(19) United States
(12) Patent Application Publication
(10) Pub. No.: US 2010/0327016 A1
(43) Pub. Date: Dec. 30, 2010

(54) Dispenser

(76) Inventor: Fredrick Michael Coory, Christchurch (NZ)

Correspondence Address: LAW OFFICES OF JAMES E. WALTON, PLLC, 1169 N. BURLESON BLVD., SUITE 107-328, BURLESON, TX, 76028, US

(21) Appl. No.: 12/594,764

(22) PCT Filed: Apr. 3, 2008
(86) PCT No.: PCT/NZ2008/000074

§ 371 Date: Sep. 16, 2010

(30) Foreign Application Priority Data
Apr. 5, 2007 (NZ) 554373

(51) Int. Cl. B67D 7/78; B65D 25/08

(52) U.S. Cl. 222/129; 206/222

(57) ABSTRACT

A dispenser for dispensing ingredients/additives into a liquid contained in a container. The dispenser (10) includes a receptacle (14) an opening (15) into the receptacle (14) through which ingredients/additives can be loaded into the receptacle. A closure (17) can fit with opening (15) for retaining ingredients/additives in the receptacle (14). The receptacle (14) is at least in part located in an enclosure (16). The receptacle (14) and enclosure (16) are arranged such that relative movement therebetween can take place. A mounting (11, 20, 21) enables the mounting the enclosure to a container (C). Relative movement between the enclosure (14) and receptacle 16 results in the closure effect of the closure (17) with opening (15) to be removed so that the ingredients/additives in the enclosure (14) can be dispensed into liquid contained in the container. The mounting (11, 20, 21) can be part of a cap which is applied to an opening of the container.

### BACKGROUND TO THE INVENTION

This invention relates to a dispenser. More particular the invention relates to a dispenser which enables ingredients or additives to be dispensed into a liquid contained in a container.

There are applications in which it is desirable to dispense a predetermined amount of ingredients/additive into a liquid contained in a container. For example it is known to dispense an additive in a powder form or in a tablet form into water contained in a container so that the powder/tablet when dispersed through the water adds flavouring, colouring, vitamins, minerals and the like into the water to create a palatable drink which can be consumed direct from the container. There are other applications where the ingredients/additives might be of a liquid form so that the liquid additive can be dispensed into the liquid in the container to be mixed and thereby to create a usable product.

One of the recognised problems with constructions previously known is that the means of adding the ingredients/additives into the liquid adds to the height of the container. This is because the construction protrudes from the container as it is part of a cap and therefore protrudes above the top of the container. This can create problems in respect of packaging where the outer packaging for a number of containers needs to be increased thereby raising issues associated with storage, transportation, etc.

### SUMMARY OF THE INVENTION

An object of the present invention is to provide a dispenser for dispensing ingredients/additives into a liquid contained in a container the dispenser being of a construction which minimises the amount of protrusion of the dispenser from the top of the container without limiting the volume of the ingredients/additives contained in the dispenser.

According to one broad aspect of the invention there is provided a dispenser for dispensing ingredients/additives into a liquid contained in a container, the dispenser including a receptacle, an opening into the receptacle through which ingredients/additives can be loaded into the receptacle, closure means for retaining the ingredients/additives in the receptacle, an enclosure in which the receptacle is at least in part located, the receptacle and enclosure being arranged such that relative movement therebetween can take place, mounting means for, in use, mounting of the enclosure within the container and means for causing relative movement to occur between the enclosure and receptacle whereby the closure effect of the closure means is removed so that the ingredients/additives can be dispensed into liquid contained in the container.

According to one form of the invention the mounting means can be a cap which is able to be applied to an opening of the container.

According to a preferred form of the invention the dispenser includes means for enabling flow of liquid containing the dispensed ingredients/additives from the container. The flow means can be a pourer, nozzle, a sipper cap and other like means which enable flow of liquid with ingredients/additives from the container.

In another preferred embodiment of the invention the dispenser can further include a second enclosure within which the said enclosure is located, the second enclosure having an opening closed by a removable sealing means.

According to one embodiment of the invention the closure can be a bung or like closure element.

According to another form of the invention the closure can be a cap or like closure means.

According to yet a further embodiment of the invention the closure can be a rupturable or pierceable cover.

In a preferred embodiment of the invention when the closure is a rupturable or pierceable cover there is further provided means for rupturing/piercing the cover. The means for rupturing/piercing the cover may be carried by the enclosure.

### BRIEF DESCRIPTION OF THE DRAWINGS

In the following more detailed description of embodiments of the invention reference will be made to the accompanying drawings in which:

FIG. 1 is an isometric view of the necked top portion of a container with a dispenser according to one embodiment of the present invention fitted therein,

FIG. 2 is a cross-sectional isometric view of the embodiment of FIG. 1 with the overcap removed and the dispenser in its closed position,

FIG. 3 is a view similar to FIG. 2 but showing the dispenser in the open position,

FIG. 4 is a view similar to FIG. 1 but showing the overcap removed and the dispenser reverted to its closed position,

FIG. 5 is an isometric sectioned view of a second embodiment in the invention with the dispenser in its closed position and an overcap located thereon,

FIG. 6 is a view similar to FIG. 5 but with the overcap removed and the dispenser moved to an open position,

FIG. 7 is a view similar to FIG. 6 but with the dispenser back in its closed position,

FIG. 8 is a further illustration of second embodiment when the dispenser is in its open position,

FIG. 9 is a sectioned perspective view of the dispenser according to the second embodiment when in the open position,

FIG. 10 is a sectioned elevation view of the dispenser according to the second embodiment when in the closed position after the initial opening of the dispenser to dispense the additives/ingredients,

FIG. 11 is an isometric view of a third embodiment of the invention,

FIG. 12 is an illustration of a third embodiment with the pourer pressed down, the additive released and the dispenser in its closed position,

FIG. 13 is a view similar to FIG. 12 but showing the dispenser moved up to an open position,

FIG. 14 is an isometric view of a fourth embodiment of the invention,

FIG. 15 is a sectioned isometric view of the forth embodiment,

FIG. 16 is a view similar to FIG. 14 but with a closure seal removed from lower end of the enclosure of the dispenser,

FIG. 17 is an illustration of the dispenser (shown in sectioned form) in conjunction with a flexible bag container,

FIG. 18 is a view similar to FIG. 17 but showing the dispenser mounted to the bag in more detail,

FIG. 19 is a view similar to FIG. 18 but showing the dispenser moved to a position where ingredients in the receptacle had been released into the bag,

FIG. 20 is a view similar to FIG. 19 but with the dispenser not shown in cross-section,

FIG. 21 is a view of the cap and receptacle shown in an inverted position to enable additive to be inserted through the opening of the receptacle, and

FIG. 22 is a view similar to FIG. 21 but showing the receptacle with a closure in the form of a bung fitted to the open end thereof.

### DETAILED DESCRIPTION OF EMBODIMENTS OF THE INVENTION

Referring firstly to FIG. 1 there is shown the top portion of a typical container C comprising a shoulder portion S merging into a neck portion N which defines the open end of the container and onto which a cap 11 of the dispenser 10 is fitted. In the illustrated form of the invention the cap 11 is, in typical fashion, screwed onto the threaded open end of the neck N but the cap 11 could be fitted in other ways such as a snap fit or the like.

In this embodiment of the invention the dispenser 10 includes a pourer nozzle 12. This is located within a removal overcap 13.

According to the preferred embodiment of the invention as illustrated the pourer nozzle 12 is coupled to a receptacle 14 which is of generally tubular form with an open lower end 15 (see FIG. 3).

The tubular receptacle 14 is of generally elongate form and is slidingly located within an enclosure 16 which in this form of the invention can be described as a cage or frame. The enclosure is thus formed from a plurality of downwardly depending arms 16a which are joined at their lower ends by inwardly directed fingers 16b. The tubular receptacle 14 can be moved upwardly and downwardly in enclosure 16 as will hereinafter be apparent.

In the assembled form of the dispenser 10 the open end 15 of the receptacle 14 is closed by a bung 17. This bung 17 is supported by the enclosure 16. Thus in the initial assembly of the dispenser 10 the receptacle 14 is filled with additive or ingredients which can be in powdered, granular or liquid form. The bung 17 seals the additive/ingredients within the receptacle 14.

The pourer nozzle 12 is coupled via a series of fingers or the like 18 to an intermediate section 19 between the nozzle 12 and receptacle 14. This will for convenience be referred to as a carrier 19. The nozzle 12, fingers 18, carrier 19 and receptacle 14 can be moulded as a single unit.

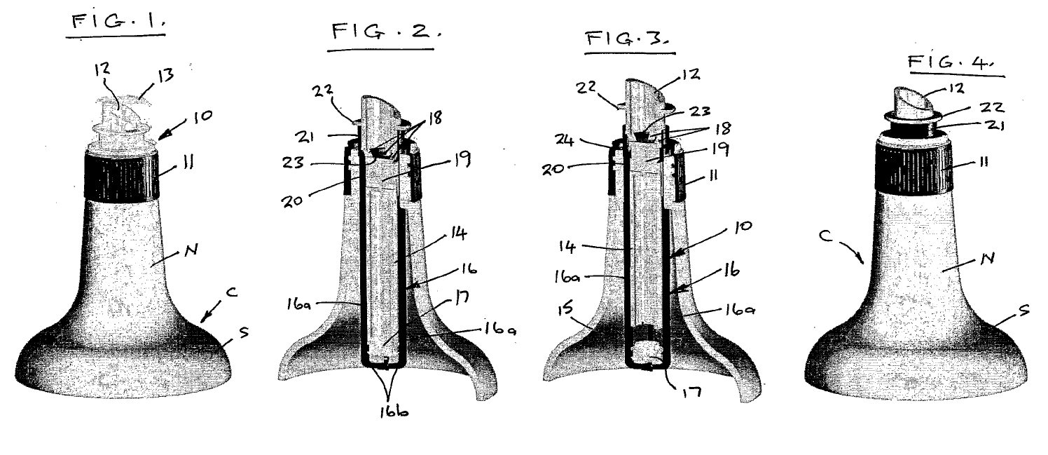

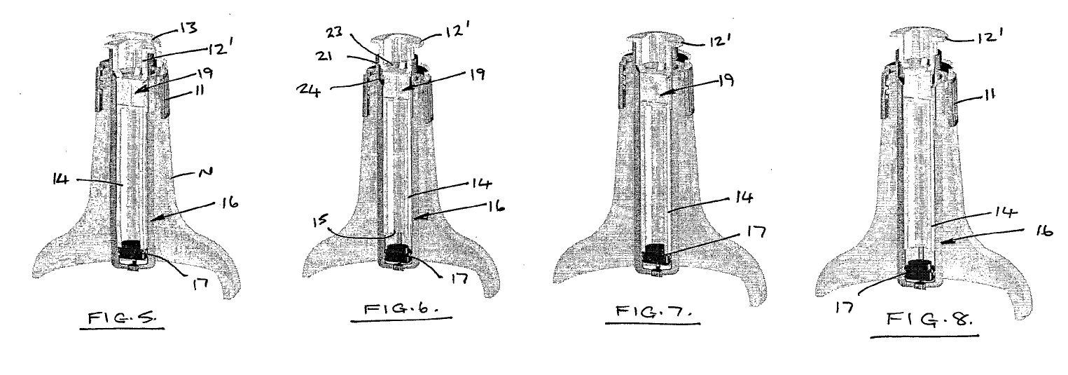

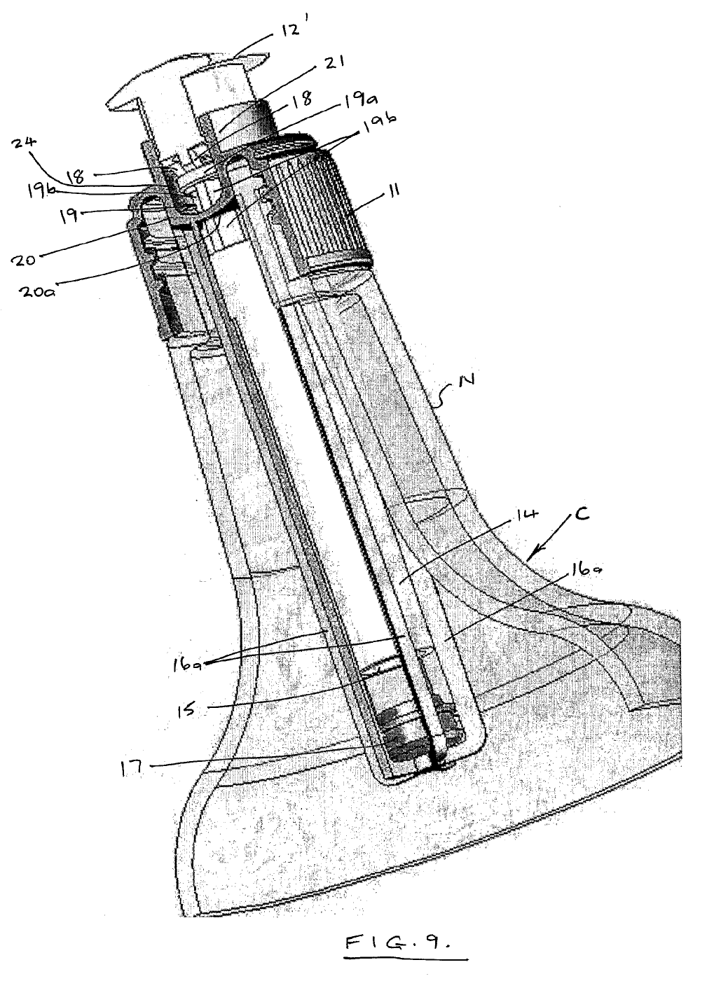

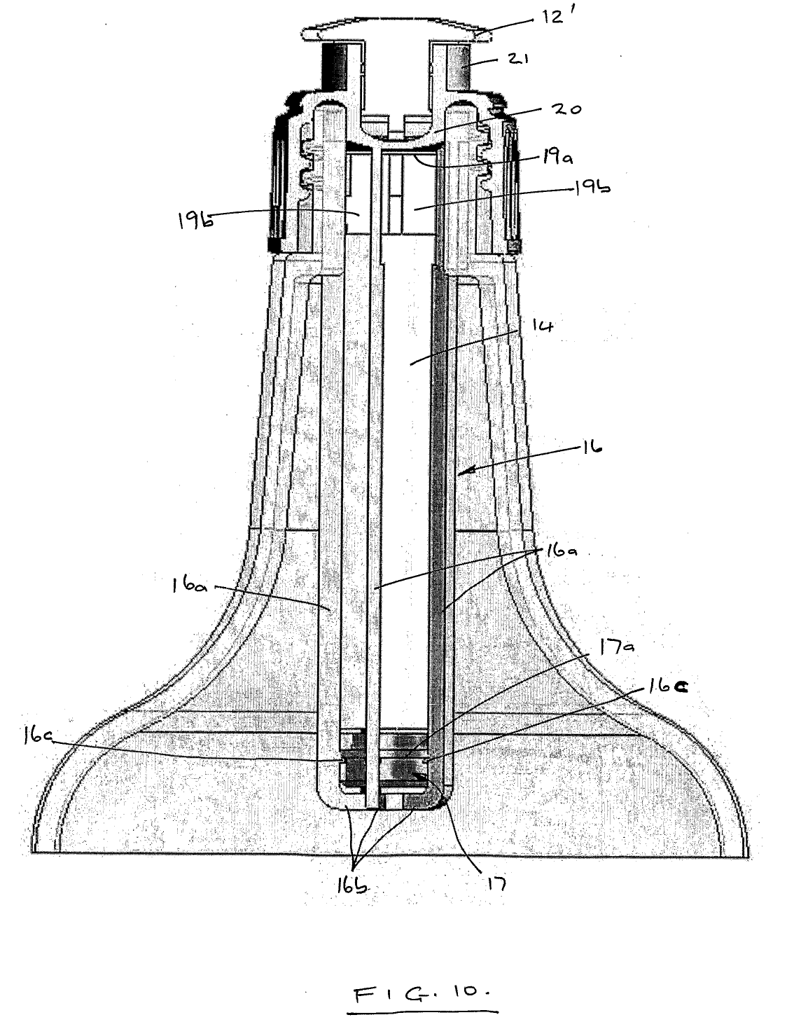

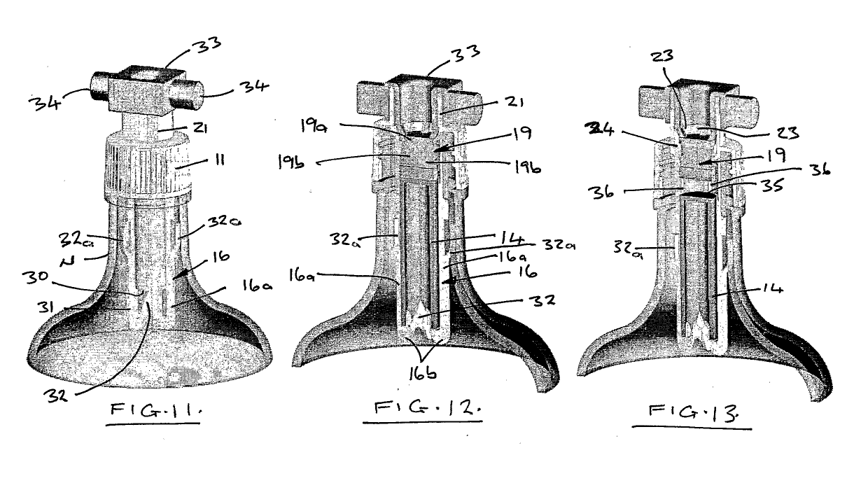

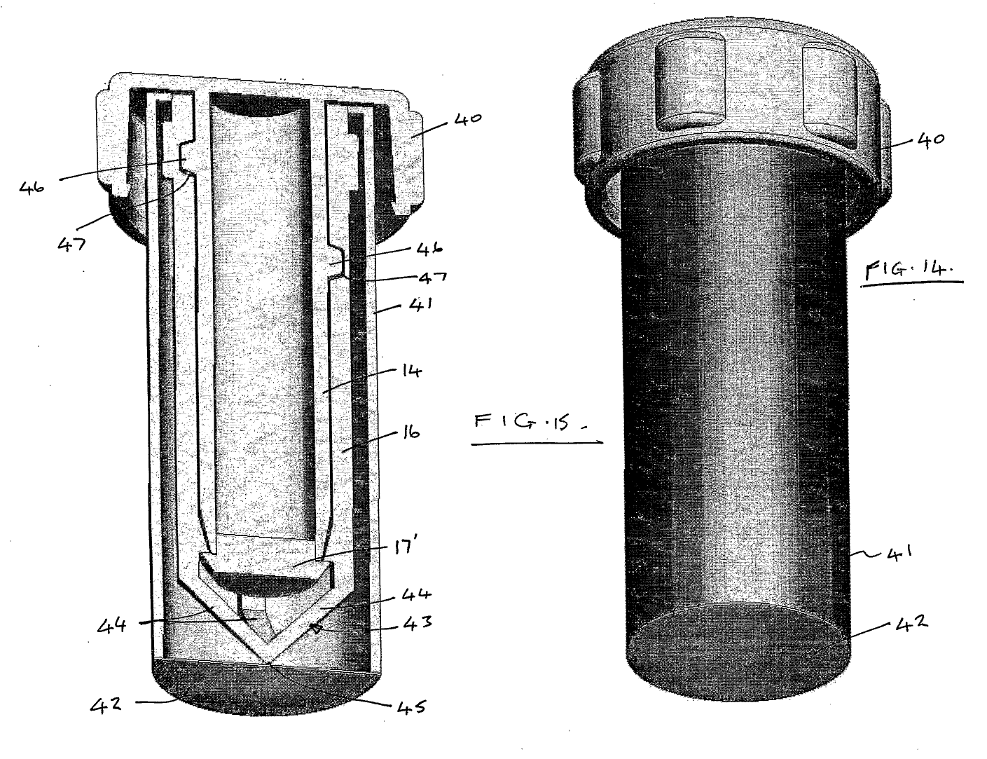

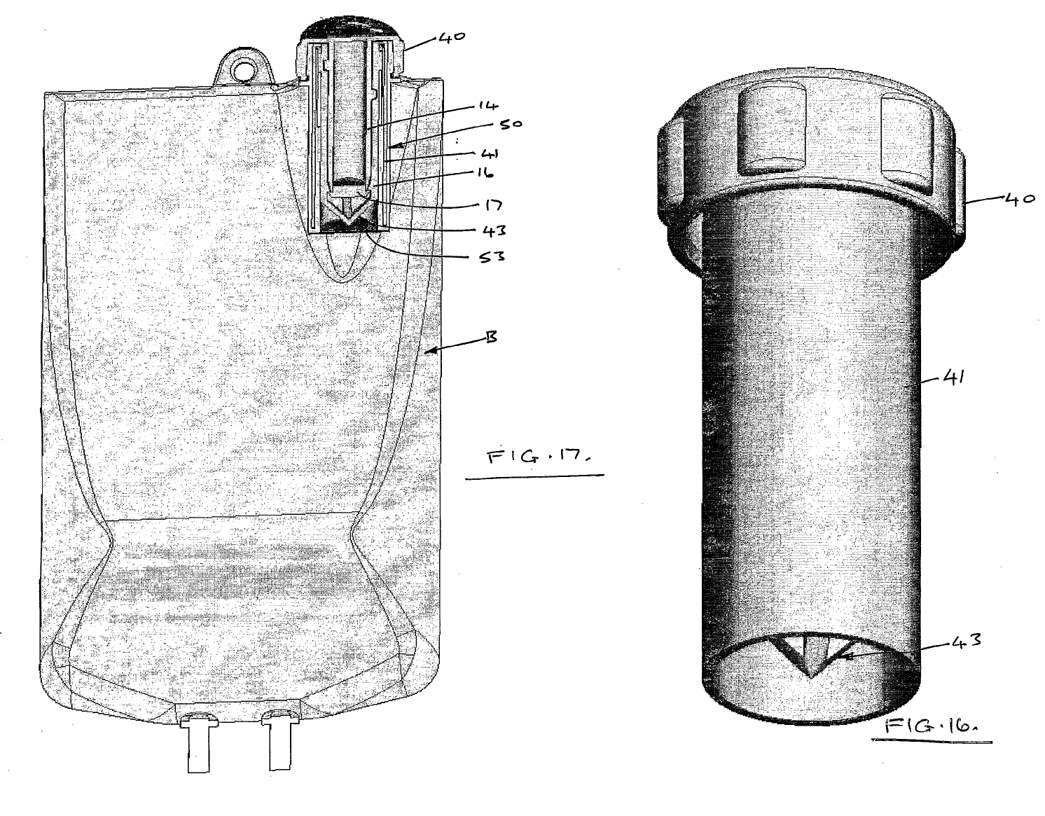

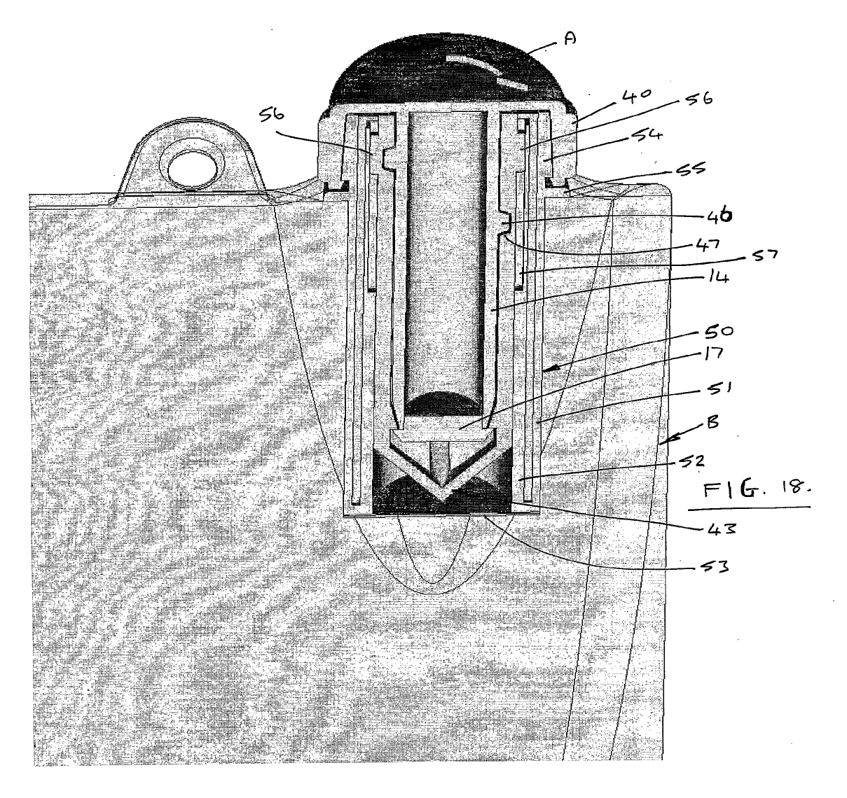

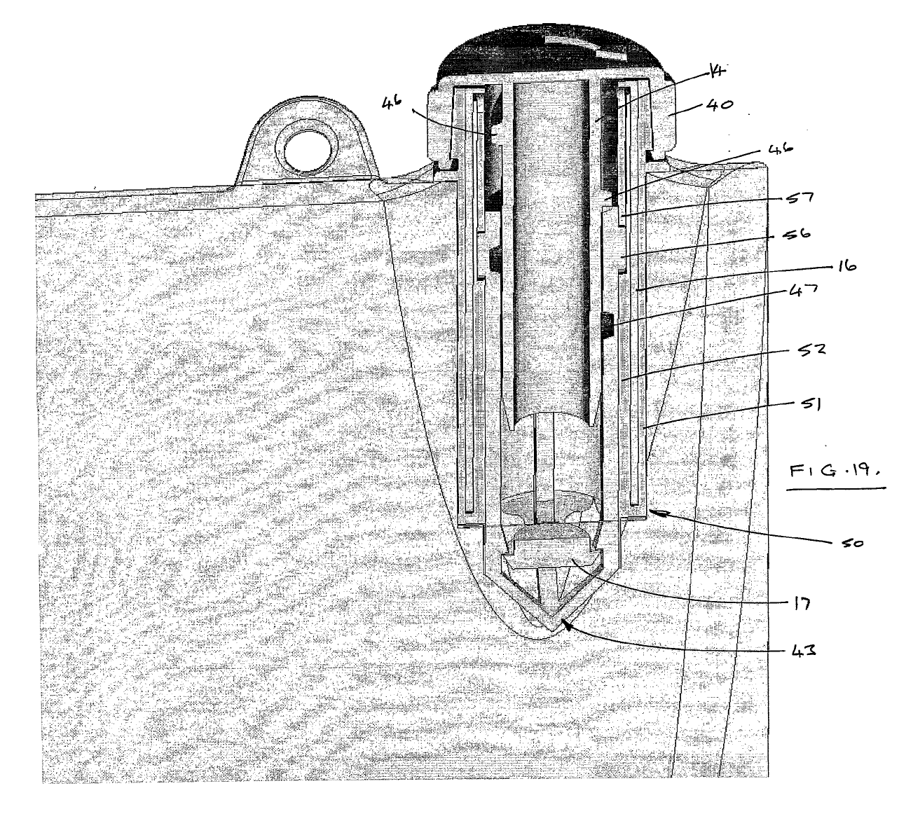

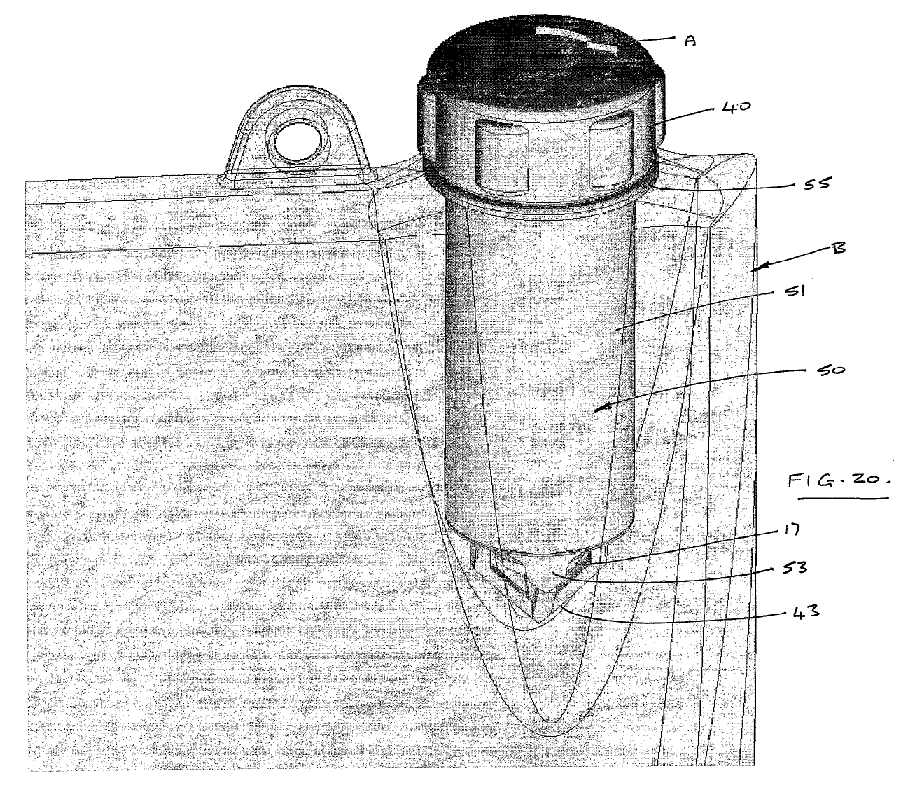

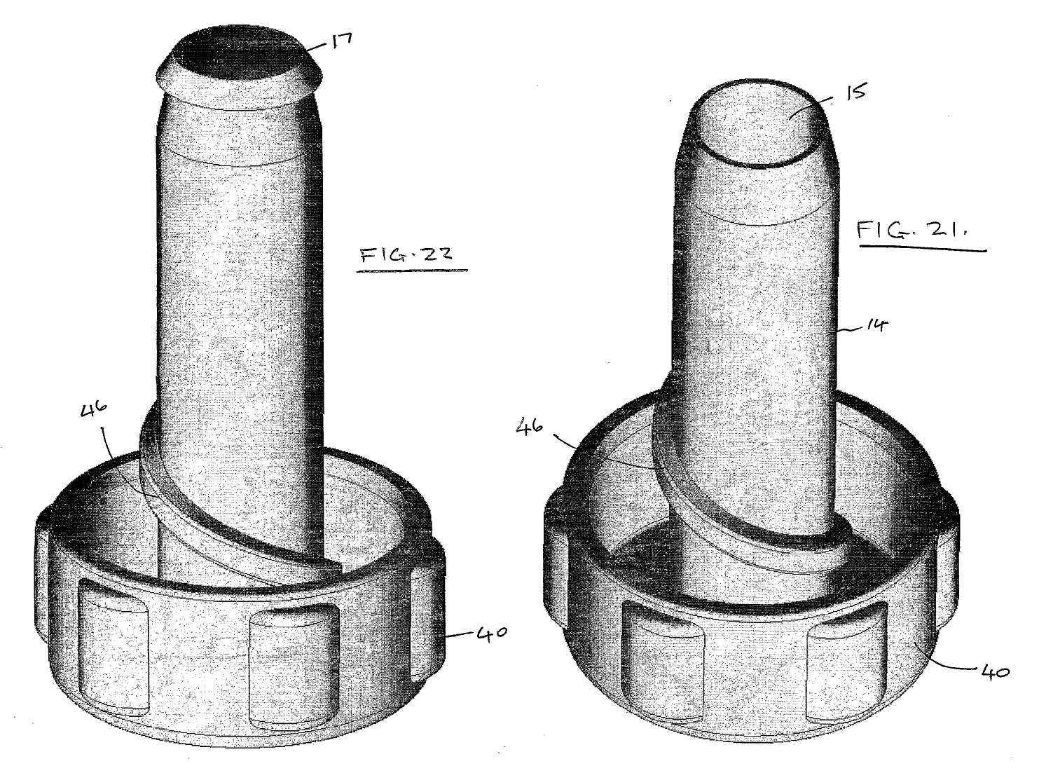

The enclosure 16 has at its upper end a body portion 20 which extends into a widened mouth 21. The carrier 19 slidingly engaged in the body portion 20 while the nozzle 12 is slidingly engaged in the mouth portion 21. The nozzle 12 preferably has a peripheral flange 22 which engages on the distal end of the mouth 21 when the dispenser is in the initial position as shown in FIG. 2 or in the closed position shown in FIG. 4.

When the dispenser 10 is mounted onto the neck N of the container C the enclosure 16 and receptacle 14 extend down within the neck and will generally reside, at least in part, in the liquid contained in the container C. With the nozzle 12 in its “down” position, as shown in FIG. 2, the openings 23 formed between the fingers 18 seal against the surface of the transition between the body 20 and the mouth 21. Also an area 19a of the carrier 19 fits into an opening 20a in the body 20. Thus, liquid in the container C is prevented from flowing into the nozzle 12. This is further explained hereinafter in relation to the second embodiment with reference to FIGS. 9 and 10.

When the nozzle 12 is pulled upwardly (see FIG. 3) liquid can flow along between the arms 16 into channels, paths, grooves, slots and the like in the carrier 19 to access the thus formed space 24 in the mouth 21. The liquid can thus flow through the openings 23 and into the nozzle 12.

It will be appreciated by those skilled in the art that various ways of achieving a flow into the mouth 21 so as to exit through openings 23 in the nozzle 12 (when the nozzle is in the open position) can be used. The actual way in which the flow is achieved is not part of the principle inventive concept of the present invention.

FIG. 3 shows the pourer 12 lifted into the open position (as described above) which draws the open end 15 of the receptacle 14 off the bung 17. Thus ingredients/additives in the receptacle 14 are free to flow into the liquid in the container C. It is envisaged that to ensure complete mixing a shaking action may need to be applied to the container so as to flush out any ingredients/additives which might remain in the receptacle 14.

Prior to carrying out this shaking of the container it may be desirable to revert the nozzle 12 to its closed position. This action will cause the lower open end 15 of the receptacle 14 to engage on the bung 17 thereby forcing the bung 17 downwardly into a lower retained position as is illustrated in FIG. 3. This ensures that the bung never reseals the receptacle 14 so that when the dispenser 10 is in the closed position liquid can still access the interior of the receptacle 14 to flush out any remaining ingredients/additives within the receptacle. This is described later with respect to FIGS. 9 and 10 showing the second embodiment.

FIG. 4 is similar to FIG. 1 and shows the pourer 12 in the down or closed position, however, the user can, at will, open and close the pourer to enable flow of liquid (with ingredients/additives) out of the container C via the nozzle 12.

FIGS. 5-8 are similar views of a second embodiment of the invention where the elements which correspond with those of the first embodiment carry the same reference numerals.

This particular embodiment has what is commonly referred to as a sports sipper top 12′ in place of the pourer 12 of the first embodiment. In all other respects, however, the second embodiment operates in the same manner. Thus in the “as supplied” configuration the sipper top 12′ is in the closed position and the ingredients/additives are enclosed within the receptacle 14 by the bung 17 sealing in the open end 15 of the receptacle 14.

The sports top can be pulled upwardly to the open position and as a result the ingredients/additives are simultaneously released from the receptacle 14 (FIG. 6). The sports top can then be pressed down to the closed position which as previously described results in the bung 17 being pushed down into a lower retained position (FIG. 8). The dispenser can then be opened and closed at will depending on the user wishing to drink from the container C via the sports sipper top 12′.

FIG. 9 shows in more detail the manner in which the flow of liquid from the container C can take place. This shows the grooves, channels etc. 19b in the carrier 19 which are able to communicate (through opening 20a in body portion 20) with the cavity 24 formed in the mouth 21 when the sipper top 12′ is moved to the open position (FIG. 9). The fluid flow passage thus created enables the liquid to then pass between the arms 16a to access channels 19b then through the opening 20a and into chamber 24.

FIGS. 9 and 10 show in more detail how the bung 17 is retained in the lowered position. This is achieved by a downwardly inclined projection (or series of projections) 16c which extend from the arms 16. The peripheral rim 17a of bung 17 engages with these to thereby retain the bung 17 in the lower position.

As is evident from FIG. 10 the bung 17 is held spaced from opening 15 when the nozzle is in the closed position.

FIGS. 11-13 show a third embodiment of the dispenser 10. Once again elements of construction which correspond with those of the first and second embodiments are indicated by the same reference numerals.

According to this embodiment of the invention the open end 15 of the receptacle 14 is closed off by a sealing foil, membrane or the like seal element 30. The lower end of the enclosure 16 (which once again is in the form of a framework or series of downwardly depending arms 16a) carries on the inward fingers 16b an upwardly facing spike or piercing/cutting element 32. To locate and provide some rigidity to the arms 16a there can be provided on each of the arms 16a an outwardly extending tab 32a which engages against the inner wall of the neck N when the dispenser 10 is installed in the neck N.

In this form of the invention a pourer 33 is provided. This has a pair of diametrically opposed outwardly projecting gripping portions 34 which enables a user to readily apply an upward or downward force to the pourer 33 depending on whether it is being closed or opened. In this respect FIG. 11 shows the dispenser 10 in an open position (as will hereinafter be described) which has the pourer 33 in the raised or upper position as shown in FIG. 11.

As shown in FIG. 12 the pourer 33 can be pressed downwardly which moves the receptacle 14 relative to the enclosure 16 and this results in the piecing/cutting member 32 rupturing/piercing the seal 30. Thus, this downward movement of the pourer 33 moves the pourer into a position where the container is closed and simultaneously causes the ingredients/additives in the receptacle 14 to be released into the container C.

As is evident in FIG. 13 the carrier 19 is not coupled to receptacle 14 so that when the pourer 33 is next moved to the upper position the receptacle 14 stays in its lower position. This creates a gap between the upper end 35 of the receptacle 14 and the carrier 19 thereby exposing openings 36 between the legs 31. Liquid in the container C can therefore pass through the openings 36 into the space between the carrier 19 and the upper end 35 of the receptacle 14 and then flow along the flow channels, grooves, slots etc. in the carrier 19 to enter the chamber 24 and hence flow through the openings 23 into the pourer 33.

The pourer 33 can then be opened and closed at will.

The first, second and third embodiments as illustrated in the drawings and described above are particularly suited for necked containers though they are additionally suited for mounting on a box or carton of the type which is commonly used for packaging of drinks and other liquid based foodstuff. Because the receptacle carrying the ingredients/additives is positioned into the container and more particular extends along the neck of the container or into the container, the object of providing a means of dispensing ingredients/additives into liquid into the container with minimal increase in the height of the container with its dispensing nozzle/sipper top etc. is achieved. The relative movement which is obtained by movement of the nozzle, pourer, sipper top etc. between the receptacle 14 and the enclosure 16 to release ingredients/additives from the receptacle 14 enables the objective of the invention to be realised.

The invention and its end use is not confined solely to drinks or foodstuffs commonly sold in bottles, containers, cartons and the like. It can also have application in the medical field or feeding of people who may not be able to normally ingest foodstuffs (fluids etc.). An embodiment of the invention for this end purpose is shown in FIGS. 14-22.

FIG. 14 shows the dispenser 10 being externally formed by a cap 40 and an outer enclosure 41. The open lower end of the enclosure 41 is sealed closed by a removal seal 42.

As can be seen FIG. 15 the receptacle 14 is formed as an integral part of the cap 40. Its open end 15 is closed by a bung 17′. As with the previous embodiments the receptacle 14 is located within an enclosure 16, the lower end of which is formed with a piercing element 43. This can be formed by a series of legs 44 which extend downwardly from the enclosure 16 to form a point 45.

The outer enclosure 41 can also be formed integrally with the inner enclosure 16.

The receptacle 14 and the inner enclosure 16 are coupled together so that relative movement therebetween can occur. Unlike the previous embodiments, however, the arrangement is such that the enclosure 16 moves on the receptacle 14. Different mechanical means of achieving this relative movement can be used but in the illustrated form of the invention mating thread forms 46 and 47 of the receptacle 14 and enclosure 16 respectively are provided.

FIG. 16 is similar to FIG. 15 but with the seal 42 removed to show the piercing construction 43.

In the illustrated form of the invention the dispenser 10 is intended for fitting to a flexible bag which can contain water, saline solution or any other stable solution into which ingredients/additives from the receptacle 14 are to be added. To this end the bag B is provided with a mounting 50 with which the dispenser 10 can be engaged. This mounting 50 essentially provides a double wall, the open lower end of which is sealed by a seal 53. The upper end of the mounting 50 is provided with an annular wall 54 onto which the cap 40 can be fitted e.g. in a snap lock arrangement. The mounting 50 can further include a shoulder or flange 55 which is used for attachments of the mounting 50 into an opening in the wall of the bag B.

In use the bag B with the mounting 50 located therein and seal 53 intact as well as closure (not shown) across the open top of the mounting 50 will be supplied to an end user, caregiver, hospital, medical institution or the like. The bag B will, as mentioned above, be filled with a stable liquid such as water, saline solution or the like. Within the receptacle 14 will be loaded the ingredients/additives. Generally this will be achieved by upending the cap 40 and receptacle 14 into the position as shown in FIG. 21 whereupon the ingredients/additives can be loaded through the open end 15 into the receptacle 14. As shown in FIG. 22 the open end can then be closed by a bung 17. The receptacle 14 with cap 40 can then be screwed into the enclosure 16 and the associated outer enclosure 41.

The receptacle 14 will generally be loaded in sterile conditions as will the loading of the enclosure 14 into the enclosure 16 and 41. Prior to use the seal 42 will be removed which will enable the outer enclosure 41 to be slid into the space provided between the spaced apart walls 51 and 52. Thus because the outer enclosure 41 is located within the double walls 51 and 52 it will not compromise the sterility of the liquid in the bag B because it does not come into contact with the contents of the bag B.

As indicated by the arrow A (see FIG. 18) a twist e.g. a half twist can be applied to the cap 40 which because of the mating thread forms 46 and 47 will cause the inner enclosure 16 to move downwardly and hence translate into a forward movement of the piercing element 43 so that it pierces the seal 53. The conclusion of this relative movement is shown in FIG. 19.

It will be noted from FIG. 19 that the upper end of the inner enclosure 16 incorporates an outwardly projecting rim or rib or series of lugs to move along grooves in the inner wall 52. Upon completion of the movement of the cap 40 the thread form 47 of the enclosure 16 disengages from the thread form 46 of the receptacle 14 thereby preventing the enclosure 16 from reverting to its former position. In this way the bung 17 which has been carried away from open end 15 of the receptacle 14 is kept clear of the open end of the mounting 50 thereby ensuring that ingredients in the receptacle 14 can become dispensed and disbursed into the liquid in the bag B.

This form of the invention is particularly useful for use with nutrition bags. These are used for example, with patients who cannot eat and therefore obtain nutrition via a tube from the nutrition bag. A problem with such nutrition bags has, to-date, been the short shelf life of the product because sensitive ingredients (e.g. vitamins) degrade in the liquid. With the present invention, however, the unstable ingredients can be kept separate in the receptacle housed within the outer enclosure 41 and can, as described above, be added just prior to use. Therefore, for the first time, it will be possible to provide nutrition bags with only the stable liquid contained therein and separately the unstable ingredients with the two being combined just prior to use. Consequently, long shelf life of both the nutrition bags and the separate ingredients/additives is achievable.

The invention in this form has application other than for nutrition bags. It can be used as a holder for medication. Thus, medication can be installed into the dispenser in say a pharmacy and then sent to a ward or other part of a health institution for combining with a drip bag or bottle (ampoule). The arrangement is, as described above, one which does not compromise the sterility of the liquid in the bag, bottle, ampoule or the like because the outer enclosure 41 of the dispenser 10 is engaged into the double wall of the mount 50 so as to not come into contact with the liquid within the bag. The internal piercing element 43, internal enclosure 16 and the receptacle 14 itself are kept sterile by virtue of the removable seal 42 which is removed just prior to the dispenser being inserted into the bag, bottle, ampoule or the like.

It will be appreciated that the dispenser can be made in different sizes depending on the volume of ingredients/additives to be dispensed.

It will be appreciated by those skilled in the art that the various embodiments of the invention as disclosed herein are open to modification. For example, with the third embodiment and ampoule which may be glass, aluminium or other non-porous material can be inserted into the receptacle 14 or form part of the receptacle 14 with a pierceable element of the ampoule being able to be pierced by the piercing/cutting element 32.

1. A dispenser for dispensing ingredients and additives into a liquid contained in a container, the dispenser comprising:
a receptacle;
an opening into the receptacle through which ingredients and additives can be loaded into the receptacle;
closure means for retaining the ingredients and additives in the receptacle;
an enclosure in which the receptacle is at least in part located, the receptacle and enclosure being arranged such that relative movement therebetween can take place;
mounting means for, in use, mounting of the enclosure within the container; and
means for causing relative movement to occur between the enclosure and receptacle whereby the closure effect of the closure means is removed so that the ingredients and additives can be dispensed into liquid contained in the container.

2. The dispenser of claim 1 wherein the mounting means is a cap which is adapted to be applied to an opening of the container.

3. The dispenser of claim 1 further comprising:
means for enabling flow of liquid containing the dispensed ingredients and additives from the container.

4. The dispenser of claim 3 wherein the means for enabling flow is one of a pourer, nozzle, and a sipper cap which enables flow from the container of liquid with ingredients and additives.

5. The dispenser of claim 1 further comprising:
a second enclosure within which the said enclosure is located, the second enclosure having an opening closed by a sealing means.

6. The dispenser of claim 5 wherein the said enclosure has a rupturing and piercing device for rupturing and piercing of the sealing means of the second enclosure.

7. The dispenser of claim 5 wherein the means for causing relative movement is mating complementary thread forms carried by the said enclosure and the receptacle.

8. The dispenser of claim 7 wherein the receptacle is fixedly attached to the mounting means.

9. The dispenser of claim 1 wherein the closure is a bung closure element.

10. The dispenser of claim 1 wherein the closure is a cap closure means.

11. The dispenser of claim 1 wherein the closure is a rupturable cover.

12. The dispenser of claim 11 further comprising:
means for rupturing and piercing the cover.

13. The dispenser of claim 12 wherein the means for rupturing and piercing the cover is carried by the enclosure.

14. A container in combination with a dispenser, comprising:
a container;
a dispenser for dispensing ingredients and additives into a liquid contained in a container, the dispenser comprising:
a receptacle;
an opening into the receptacle through which the ingredients and additives can be loaded into the receptacle;
closure means for retaining the ingredients and additives in the receptacle;
an enclosure in which the receptacle is at least in part located, the receptacle and enclosure being arranged such that relative movement therebetween can take place;
mounting means for, in use, mounting of the enclosure within the container; and
means for causing relative movement to occur between the enclosure and receptacle;
whereby the closure effect of the closure means is removed so that the ingredients and additives can be dispensed into liquid contained in the container.

15. The combination of claim 14 wherein the container has an opening into which the dispenser is engaged the opening having a neck to which the mounting means of the dispenser is engaged.

16. The combination of claim 15 wherein the enclosure is fixed in position relative to the mounting means and the receptacle is moveable relative to the mounting means.

17. The combination of claim 16 wherein the enclosure includes retention means for retaining the closure following initial relative movement between the receptacle and the said enclosure.

18. A container in combination with a dispenser, comprising:
a container;
a dispenser for dispensing ingredients and additives into a liquid contained in a container, the dispenser comprising:
a receptacle;
an opening into the receptacle through which the ingredients and additives can be loaded into the receptacle;
closure means for retaining the ingredients and additives in the receptacle;
an enclosure in which the receptacle is at least in part located, the receptacle and enclosure being arranged such that relative movement therebetween can take place;
mounting means for, in use, mounting of the enclosure within the container; and
means for causing relative movement to occur between the enclosure and receptacle;
wherein the container has an opening and inwardly extending into the container a dispenser mounting into which the second enclosure of the dispenser is engaged.

19. The combination of claim 18 wherein the dispenser mounting is open ended at an inner end and the open end is covered by a seal.

20. The combination of claim 19 wherein the dispenser mounting has two spaced apart walls and the second enclosure is located between the two walls and is thereby isolated from liquid contained in the container.

21. The dispenser of claim 1 wherein the closure is a pierceable cover.
